(19) United States
(12) Patent Application Publication
(10) Pub. No.: US 2026/0095894 A1
(43) Pub. Date: Apr. 2, 2026

(54) TRIGGERING CONDITIONS FOR DUPLICATE PAGING MESSAGE TRANSMISSION

(71) Applicant: Sharp Kabushiki Kaisha, Osaka (JP)

(72) Inventors: Zhanping Yin, Vancouver, WA (US); Atsushi Ishii, Vancouver, WA (US); Tomoki Yoshimura, Camas, WA (US)

(21) Appl. No.: 18/902,116

(22) Filed: Sep. 30, 2024

(51) Int. Cl. H04W 68/02; H04W 74/0833

(52) U.S. Cl. CPC H04W 68/02; H04W 74/0858

(57) ABSTRACT

An electronic device or an Ambient Internet of Things (AIoT) reader is described. The electronic device includes memory for storing instructions and a processor configured to execute the instructions. The instructions cause the electronic device to send a message on a physical random downlink control channel (PRDCH). The message includes any combination of a paging identification (ID), a reader ID, and a paging re-transmission counter for random access paging. The instructions further cause the electronic device to receive a second message from energy harvesting electronic devices in a contention access region and to determine whether to send a duplicate message based on second message detection results.

### TECHNICAL FIELD

The present disclosure relates generally to communication systems. More specifically, the present disclosure relates to systems and methods for indication and detection of new or duplicate paging messages.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility, and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a diagram illustrating an example of a wireless communication system;

FIG. 2 is a table illustrating an example of parameters related to subcarrier spacing;

FIG. 3 is a diagram illustrating an example of 2-step contention-based random access procedures;

FIG. 4 is a diagram illustrating an example of a 3-step contention-based random access procedure;

FIG. 5 is a flow diagram illustrating an example of a method by an AIoT (ambient power-enabled Internet of Things) reader;

FIG. 6 is a flow diagram illustrating an example of a method by an AIoT device;

FIG. 7 is a flow diagram illustrating an example of a method by an AIoT reader;

FIG. 8 is a flow diagram illustrating another example of a method by an AIoT device;

FIG. 9 is a flow diagram illustrating another example of a method by an AIoT reader;

FIG. 10 is a flow diagram illustrating another example of a method by an AIoT device;

FIG. 11 is a flow diagram illustrating a further example of a method by an AIoT reader;

FIG. 12 is a flow diagram illustrating a further example of a method by an AIoT device;

FIG. 13 is a flow diagram illustrating a further example of a method by an AIoT reader;

FIG. 14 is a block diagram illustrating one implementation of an energy harvesting node for wireless communication; and

FIG. 15 is a block diagram illustrating one implementation of a node for wireless communication.

### DETAILED DESCRIPTION

An electronic device or an Ambient Internet of Things (AIoT) reader is described. The electronic device includes memory for storing instructions and a processor configured to execute the instructions. The instructions cause the electronic device to send a message on a physical random downlink control channel (PRDCH). The message includes any combination of a paging identification (ID), a reader ID, and a paging re-transmission counter for random access paging. The instructions further cause the electronic device to receive a second message from energy harvesting electronic devices in a contention access region and to determine whether to send a duplicate message based on second message detection results.

In some examples, the processor may be configured to send the duplicate message when the second message detection results include detecting a collision in one or more random access opportunities (ROs).

In other examples, the processor may be configured to send the duplicate message when the second message detection results include detecting more than one energy harvesting electronic device reporting the same random ID.

The processor may also be configured to send the duplicate message when the second message detection results include determining that more responses from energy harvesting electronic devices are expected. Determining that more responses are expected may include determining that some energy harvesting electronic devices sent a prior second message in a previous random access region.

In some implementations, the processor may be configured not to send a subsequent duplicate message when all random access opportunities (ROs) in a previous contention access region are detected as idle.

In other examples, the processor may be configured not to send a subsequent duplicate message when no second messages are received and no collisions are detected.

A method is also described. The method includes sending a message on a physical random downlink control channel (PRDCH). The message may include any combination of a paging identification (ID), a reader ID, and a paging re-transmission counter for random access paging. The method further includes receiving a second message from energy harvesting electronic devices in a contention access region and determining whether to send a duplicate message based on second message detection results.

One of the three fundamental use cases for development of the 3GPP 5G technologies is Narrowband Internet of Things machine type communications (NB-IoT/MTC). The NB-IoT is a standards-based low power wide area (LPWA) technology that is developed to enable a wide range of new IoT devices and services. NB-IoT significantly improves the power consumption of user devices, system capacity, and spectrum efficiency, especially in deep coverage.

Some of the IoT devices may achieve a battery life of more than 10 years, which may be desirable in a wide range of use cases. New physical layer signals and channels are designed for 3GPP New Radio (NR) to meet the demanding requirement of extended coverage (e.g., for rural and deep indoors application) and ultra-low device complexity. The initial cost of the NB-IoT devices is expected to be a significant market driver for the uptake of this technology. The underlying technology of the NB-IoT devices is, however, much simpler than the existing solutions and its cost is expected to decrease rapidly as demand increases.

The MTC, also referred to as machine to machine (M2M), represents the broad area of wireless communication with sensors, actuators, physical objects, and other devices that are not directly operated by humans. The MTC communication denotes a data channel between two entities without the involvement of a human. This communication is typically between an MTC device and an MTC server. A prime example of MTC communication is the smart metering for utility services such as gas, water, and electricity. The MTC communication may also be between the MTC devices (e.g., IoT devices), without the involvement of an MTC server.

An ambient power-enabled Internet of Things (ambient power-enabled IoT or AIoT) device is an IoT device that is powered by energy harvesting. The harvested power may be obtained from the energy that is inherently available in the device's environment. Typically, an energy harvesting wireless terminal may not have a conventional battery, and the device may use energy harvested from the environment in lieu of a dedicated internal power source.

The output power of the energy harvester is typically from 1 μW to a few hundreds of μW. Existing cellular devices may not work well with energy harvesting due to their peak power consumption of higher than 10 mW.

Such a device may be capable of either harvesting, storing, and subsequently using, or harvesting and immediately using, energy from wireless radio waves or any other form of energy that may be locally obtained to meet the needs of a particular application. For example, in some scenarios, an AIoT device may harvest energy from radio waves that may come from 5G NR network entities (e.g., a next-generation Node B (gNB), or customer premise equipment (CPE)) or from user equipment (e.g., hand held devices or IoT devices). In some other scenarios, an AIoT device may harvest energy from solar, light, motion/vibration, heat, pressure, or any other potential energy sources.

The 3GPP (e.g., as indicated in Release 19 (Rel-19) of 3GPP Services and System Aspects (SA) Working Group 1 (WG1) (more commonly known as SA1)) has conducted an overall service description (e.g., in a stage 1 level study) on the support of ultra-low power applications. In the ultra-low power applications, the power requirements of a device may be satisfied from local energy harvesting by the device. For example, a device may include no battery and may derive sufficient operating energy from the local environment. The energy may be used either immediately or may be stored in a capacitor for later use. The study was preceded by an agreement in SA1 of a Work Item Description (WID) document. That document provides the justification of the work and an outline of the scope of the work that is expected to take place with respect to developing a Technical Report (TR). The latest revision of the WID may be found in SP-220085.

The results of the SA1 stage 1 study that was concluded in December 2022 were published in TR 22.840 v1.0.0 and the normative work was concluded in November of 2023. The study covered use cases, traffic scenarios, and device constraints of AIoT devices. The study identified new potential service requirements as well as new key performance indicators (KPIs) as related to 3GPP NR type devices, access network, and core network.

An example type of application in TR 22.840 is asset identification, which presently has to resort mainly to barcode and Radio Frequency Identification (RFID) in most industries. The main advantage of these two technologies is the ultra-low complexity and small form factor of the tags. However, the limited reading range of a few meters usually requires handheld scanning which leads to labor intensive and time-consuming operations, or RFID portals/gates which leads to costly deployments. Moreover, the lack of interference management scheme results in severe interference between RFID readers and capacity problems, especially in case of dense deployment. It is hard to support large-scale network with seamless coverage for RFID.

Technical Specification Group for Radio Access Network (TSG RAN) has completed a Rel-18 RAN-level System Information (SI) on Ambient IoT, which provides a terminological and scoping framework for future discussions of Ambient IoT. This has defined representative use cases, deployment scenarios, connectivity topologies, Ambient IoT devices, design targets, and required functionalities; it also conducted a preliminary feasibility assessment, and gave recommendations for down-selection in setting the scope of a further WG-level study. Ambient IoT can be abbreviated as AIoT or A-IoT. Ambient IoT device is also known as energy harvesting device.

Since existing technologies cannot meet all the requirements of target use cases, a new IoT technology is recommended to open new markets within 3GPP systems, whose number of connections and/or device density can be orders of magnitude higher than existing 3GPP IoT technologies. The new IoT technology shall provide complexity and power consumption orders of magnitude lower than the existing 3GPP LPWA technologies (e.g. NB-IoT and enhanced Machine-Type Communication (eMTC)), and shall address use cases and scenarios that cannot otherwise be fulfilled based on existing 3GPP LPWA IoT technologies.

The study targets a further assessment at RAN WG-level of Ambient IoT, a new 3GPP IoT technology, suitable for deployment in a 3GPP system, which relies on ultra-low complexity devices with ultra-low power consumption for the very-low end IoT applications. The study shall provide clear differentiation, i.e. addressing use cases and scenarios that cannot otherwise be fulfilled based on existing 3GPP LPWA IoT technology e.g. NB-IoT including with reduced peak Tx power. The study shall target for an IoT segment well below the existing 3GPP IoT technologies, e.g. NB-IoT, eMTC, RedCap, etc. The study shall not aim to replace existing 3GPP LPWA technologies.

Massive MTC (mMTC) is one important use case for 5G that was discussed in the WID. However, there are still several important use cases and scenarios that are not adequately covered by 3GPP Rel-18 technologies. These uses cases include ultra-low complexity devices, very small device size/form factor (e.g., thickness of mm) devices, maintenance-free (e.g., no need to replace a conventional battery for the device) devices, devices with a longer life cycle, and device deployment where a conventional battery is not applicable.

To address at least the use cases above, the SA1 has conducted a study on IoT service using an IoT device powered by energy harvesting, where a device powered by such energy harvesting may support IoT communications without relying on conventional power sources and/or avoiding human intervention for recharging or replacing. The study results may be found in SP-231405 and the resulting technical specification may be found in TS 22.369. In addition to the low power consumption of such AIoT device, the study also considers low device complexity, small device size, and a device with a long-life cycle.

Some of the potential challenges of AIoT devices may include: an extremely low complexity device form factor, the ability to harvest energy and at the same time use the harvested energy to support communication, the capability to provide sufficient communication services to fulfil the corresponding requirements, the capability to provide user privacy, and the capability to provide data security.

In many use cases, the life cycle of an AIoT device may need to be properly managed so as to meet user and institutional expectations. For example, when an AIoT device is deployed to track an item in a warehouse, the device may only be intended to be used when the tracked item is being transferred, stored, loaded/unloaded, and inventoried in the warehouse. Then, subsequent to its use in the warehouse, the device may be discarded. Thus, in the interests of protecting the privacy and security of information that may be retained on the device, the device may not be allowed access to, or access by, the 5GS when the device has come to the end of its intended use. In addition, the device may not be allowed access to, or access by, the 5GS when the device has come to an end of its intended use in order to avoid interference to other devices that may be using resources of the 5G system (5GS), such as Radio Frequency (RF) resources.

The 3GPP (e.g., as indicated in TS22.369) defines the communication aspects of an AIoT device as a functional service requirement as follows. The 5G system shall be able to support 5G network or an Ambient IoT capable UE to communicate with a group of Ambient IoT devices simultaneously. The 5G network shall support a mechanism to authorize an Ambient IoT capable UE to communicate with an Ambient IoT device. The 5G system shall be able to support mechanisms to communicate between an Ambient IoT device and the 5G network using Ambient IoT direct network communication or Ambient IoT indirect network communication, or between an Ambient IoT device and Ambient IoT capable UE using Ambient IoT device to UE communication. Examples of the communication between 5G network/Ambient IoT capable UE and Ambient IoT devices can include periodic sensor reporting or network-initiated inventory. The 5G system shall provide suitable mechanisms to support communication between a trusted and authorized 3rd party and an Ambient IoT device or group of Ambient devices.

A radio communication network architecture (e.g., a Long-Term Evolution (LTE) system, an LTE-Advanced (LTE-A) system, an LTE-Advanced Pro system, or a 5G NR Radio Access Network (RAN)) typically includes at least one base station (BS), at least one UE, and one or more optional network elements that provide connection towards a network. The UE communicates with the network (e.g., a Core Network (CN), an Evolved Packet Core (EPC) network, an Evolved Universal Terrestrial Radio Access network (E-UTRAN), a 5G Core (5GC), or an internet), through a RAN established by one or more BSs.

It should be noted that, in the present application, a UE (or a terminal device) may include, but is not limited to, a mobile station, a mobile terminal or device, a user communication radio terminal. For example, a UE may be a portable radio equipment, which includes, but is not limited to, a mobile phone, a tablet, a wearable device, a sensor, a vehicle, or a Personal Digital Assistant (PDA) with wireless communication capability. The UE is configured to receive and transmit signals over an air interface to one or more cells in a radio access network.

A BS may be configured to provide communication services according to at least one of the following Radio Access Technologies (RATs): Worldwide Interoperability for Microwave Access (WiMAX), Global System for Mobile communications (GSM, often referred to as 2G), GSM Enhanced Data rates for GSM Evolution (EDGE) Radio Access Network (GERAN), General Packet Radio Service (GPRS), Universal Mobile Telecommunication System (UMTS, often referred to as 3G) based on basic wideband-code division multiple access (W-CDMA), high-speed packet access (HSPA), LTE, LTE-A, eLTE (evolved LTE, e.g., LTE connected to 5GC), NR (often referred to as 5G), and/or LTE-A Pro. However, the scope of the present application should not be limited to the above-mentioned protocols.

A BS may include, but is not limited to, a node B (NB) as in the UMTS, an evolved node B (eNB) as in the LTE or LTE-A, a radio network controller (RNC) as in the UMTS, a BS controller (BSC) as in the GSM Enhanced Data rates for GSM Evolution (EDGE) Radio Access Network (GERAN), a next-generation eNB (ng-eNB) as in an Evolved Universal Terrestrial Radio Access (E-UTRA) BS in connection with the 5GC, a next-generation Node B (gNB) as in the 5G Access Network (5G-AN), and any other apparatus capable of controlling radio communication and managing radio resources within a cell. The BS may connect to serve the one or more UEs through a radio interface to the network.

The BS may be operable to provide radio coverage to a specific geographical area using several cells included in the RAN. The BS may support the operations of the cells. Each cell may be operable to provide services to at least one UE within its radio coverage. Specifically, each cell (often referred to as a serving cell) may provide services to serve one or more UEs within its radio coverage (e.g., each cell schedules the DL and optionally the UL resources to at least one UE within its radio coverage for DL and optionally UL packet transmission). The BS may communicate with one or more UEs in the radio communication system through the cells.

A cell may allocate sidelink (SL) resources for supporting Proximity Service (ProSe) or V2X services. Each cell may have overlapped coverage areas with other cells. In Multi-RAT Dual Connectivity (MR-DC) cases, the primary cell of a Master Cell Group (MCG) or a Secondary Cell Group (SCG) may be referred to as a Special Cell (SpCell). A Primary Cell (PCell) may refer to the SpCell of an MCG. A Primary SCG Cell (PSCell) may refer to the SpCell of an SCG. MCG may refer to a group of serving cells associated with the Master Node (MN), including the SpCell and optionally one or more Secondary Cells (SCells). An SCG may refer to a group of serving cells associated with the Secondary Node (SN), including the SpCell and optionally one or more SCells.

The frame structure for NR is to support flexible configurations for accommodating various next generation (e.g., 5G) communication requirements, such as Enhanced Mobile Broadband (eMBB), mMTC, Ultra-Reliable and Low-Latency Communication (URLLC), while fulfilling high reliability, high data rate and low latency requirements. The Orthogonal Frequency-Division Multiplexing (OFDM) technology as agreed in 3GPP may serve as a baseline for NR waveform. The scalable OFDM numerology, such as the adaptive sub-carrier spacing, the channel bandwidth, and the Cyclic Prefix (CP) may also be used. Additionally, two coding schemes are considered for NR: (1) Low-Density Parity-Check (LDPC) code and (2) Polar Code. The coding scheme adaption may be configured based on the channel conditions and/or the service applications.

Moreover, it is also considered that in a transmission time interval TX of a single NR frame, a downlink (DL) transmission data, a guard period, and an uplink (UL) transmission data should at least be included, where the respective portions of the DL transmission data, the guard period, the UL transmission data should also be configurable, for example, based on the network dynamics of NR. In addition, sidelink resources may also be provided in an NR frame to support ProSe services, (E-UTRA/NR) sidelink services, or (E-UTRA/NR) V2X services.

The next-generation (e.g., 5G NR) wireless network is envisioned to support more capacity, data, and services. A UE configured with multi-connectivity may connect to a Master Node (MN) as an anchor and one or more Secondary Nodes (SNs) for data delivery. Each one of these nodes may be formed by a cell group that includes one or more cells. For example, a Master Cell Group (MCG) may be formed by an MN, and a Secondary Cell Group (SCG) may be formed by an SN. In other words, for a UE configured with dual connectivity (DC), the MCG is a set of one or more serving cells including the PCell and zero or more secondary cells. Conversely, the SCG is a set of one or more serving cells including the PSCell and zero or more secondary cells.

The Primary Cell (PCell) may be an MCG cell that operates on the primary frequency, in which the UE either performs the initial connection establishment procedure or initiates the connection reestablishment procedure. In the MR-DC mode, the PCell may belong to the MN. The Primary SCG Cell (PSCell) may be an SCG cell in which the UE performs random access (e.g., when performing the reconfiguration with a sync procedure). In MR-DC, the PSCell may belong to the SN. A Special Cell (SpCell) may be referred to a PCell of the MCG, or a PSCell of the SCG, depending on whether the Medium Access Control (MAC) entity is associated with the MCG or the SCG. Otherwise, the term Special Cell may refer to the PCell. A Special Cell may support a Physical Uplink Control Channel (PUCCH) transmission and contention-based Random Access and may always be activated. Additionally, for a UE in an RRC_CONNECTED state that is not configured with the CA/DC, may communicate with only one serving cell (SCell) which may be the primary cell. Conversely, for a UE in the RRC_CONNECTED state that is configured with the CA/DC a set of serving cells including the special cell(s) and all of the secondary cells may communicate with the UE.

An AIoT reader is an electronic device that can directly communicate with one or more AIoT devices. Ambient IoT (AIoT) systems support mechanisms for the AIoT reader to be able to trigger multiple/subsequent AIoT paging messages that are associated with the same request from the core network (CN). For example, an AIoT reader may need to send multiple paging messages to collect more feedback from AIoT devices. The reader may need to cover different directions for the same paging message. Therefore:
Some mechanisms should be defined to identify whether a paging Msg0 is a new paging process or a duplicate/re-transmission of an ongoing paging process.
On the other hand, the AIoT devices should try to avoid duplicated response for the same paging process. How to determine whether a Msg1 transmission is needed based on the paging message should be further defined.
Furthermore, some device-to-relay (D2R) messages are not acknowledged in the random access (RA) procedures, e, g, a Msg 1 in a 2-step Contention-Based Random Access (CBRA) without Msg 2, and a Msg 3 in 3-step CBRA. How to handle collision/lost cases, and how to perform failure/success indication of D2R transmissions should be studied.

Any operations of the AIoT device may rely on energy harvesting schemes to collect sufficient energy from the environment, such as communications to an AIoT reader (i.e., transmission and reception of messages wirelessly), internal device management, and data processing. When a RA procedure gets initiated by the paging Msg0, the AIoT may or may not be able to complete the whole process of the RA procedure, depending on the availability and amount of harvested energy. With lack of effective solutions to deal with such uncertainty of available energy, any device-to-reader communication would always have risks to break in a non-graceful manner.

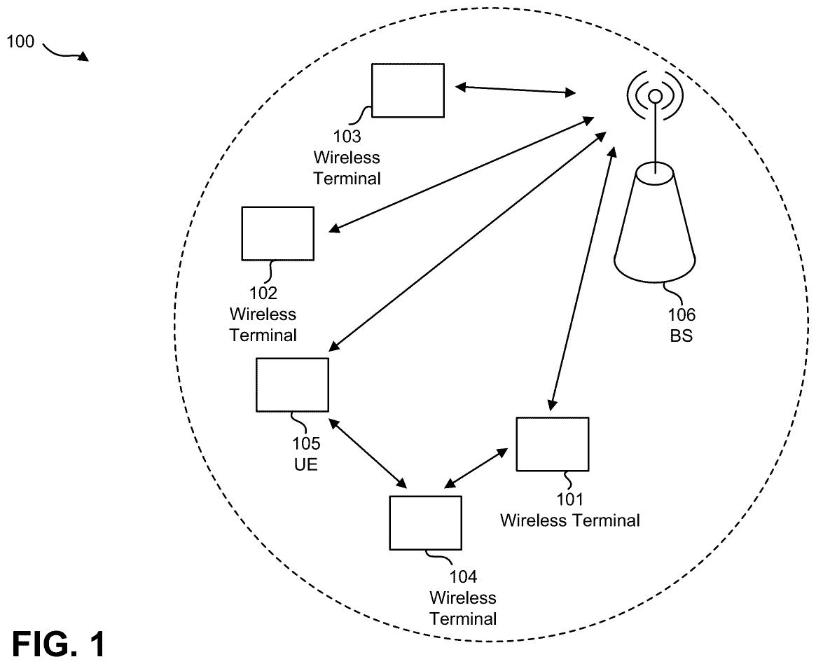

FIG. 1 is a schematic diagram illustrating a wireless communication system 100, according to an example implementation of the present disclosure. In FIG. 1, the wireless communication system 100 includes the wireless terminals 101-104, the UE 105, and the BS 106. The terms base station device, base station, and BS herein may be used interchangeably.

The BS 106 may communicate with one or more wireless terminals, such as wireless terminals 101-103 and the UE 105, through one or more cells. A cell is defined as a set of resources used for a wireless communication. A cell may include one or both of a downlink component carrier and an uplink component carrier. A downlink component carrier and an uplink component carrier may also be referred to as component carriers.

The wireless terminals 101-104 may be energy harvesting wireless terminals. Some of the energy harvesting wireless terminals may be of such limited capability that they may have minimal or no capacity to receive DL signals from the BS 106 (or transmit UL signals to the BS 106). In the example of FIG. 1, the wireless terminals 101-103 may be able to generate enough power, and/or may be in close vicinity of the BS 106, that it may be able to communicate directly (e.g., through UL and/or DL signals) with the BS. The wireless terminal 104, on the other hand, may be able to directly communicate with the UE 105 or with another wireless terminal device 101 (e.g., through SL signals) without the participation of the BS 106 in the transmission and reception of data traffic.

The wireless terminals 101-104 may be AIoT devices that harvest energy from radio waves, solar, light, motion, vibration, heat, pressure, or any other power sources. The energy harvesting by a wireless terminal device may be continuous or incidental. It is also possible that the network controls when or where some forms of harvestable power, such as radio waves, are provided. An energy harvesting wireless terminal may not always have enough power to initiate or receive communication.

The operation of a battery-less energy harvesting wireless terminal (e.g., the activation and operation of the energy harvesting wireless terminal's microprocessor and other device components dependent upon the microprocessor's operation) may be dependent upon a harvestable energy source that is immediately available to the device and of a duration sufficient to power the device to the completion of its intended operational time frame.

An energy harvesting wireless terminal may have limited energy storage capability (e.g., a capacitor) in which case the operation of the device may be independent of an immediate availability and/or temporal harvestable energy source, and the device may store the harvested energy when available and use the stored energy as needed and as sufficient to power the device for a duration that is necessary to complete the device's intended operational time frame.

The energy harvesting wireless terminal may have low complexity, small size, lower capabilities, and lower power consumption than previously defined 3GPP IoT devices (e.g., NB-IoT/enhanced Machine Type Communication (eMTC) devices). The energy harvesting wireless terminal may be maintenance free and may have long life span (e.g., more than 10 years). However, the life span of an energy harvesting wireless terminal may also be relatively short, such as, when tracking a package through a logistics chain.

The low complexity of an energy harvesting wireless terminal may be reflected in the energy harvesting wireless terminal's efficient use of 3GPP UL and DL time and frequency resources when communicating with a BS or when communicating with other devices capable of using 3GPP UL and DL time and frequency resources. The low complexity of an energy harvesting wireless terminal may be reflected in a BS's efficient use of 3GPP UL and DL time and frequency resources when communicating with an energy harvesting wireless terminal. The energy harvesting wireless terminals may have low data usage. Generally, energy harvesting wireless terminal data transmissions may contain only a few hundred bits of data.

As discussed above, such energy harvesting wireless terminals lead to new functional and performance requirements to a 5G system. Specifically, the energy harvesting wireless terminals use cases require new functional requirements, for example, communication aspects of energy harvesting wireless terminals and networks, positioning of energy harvesting wireless terminals, management of energy harvesting wireless terminals, exposure of related network capabilities, of data collected by the energy harvesting wireless terminals and of information about the energy harvesting wireless terminals, charging, security, and privacy. The implementations provided in this disclosure discuss efficient communication mechanisms between such wireless terminals that require minimum power for signal transmission and/or reception.

### NR Frame Structure

The 5G NR Frame structure is described in the NR 3GPP standards (e.g., Technical Specification (TS) 38.211). The 5G NR frame structure includes subframes, slots, and symbol configurations. The 5G NR supports two frequency ranges: FR1 (which is under 7.125 gigahertz (GHz)) and FR2 (also known as millimeter wave range, which is between 24.25 GHz to 71.2 GHz). NR uses flexible subcarrier spacing derived from basic 15 kilohertz (kHz) subcarrier spacing that is also used in the LTE. A frame may have a duration of 10 milliseconds (ms) which may include 10 subframes each having 1 ms duration, which is similar to the LTE networks. Each subframe may have 2^{μ} slots (μ being a member of the set of [0.4]). Each slot may typically include 14 OFDM symbols. The number of symbols, however, may depend upon the start and length indicator value (SLIV). The radio frames of 10 ms may be transmitted continuously one after the other as per Time Division Duplex (TDD) or Frequency Division Duplex (FDD) topology. A subframe may be of a fixed duration (e.g., 1 ms) whereas a slot's length may vary based on a subcarrier spacing (SCS) and the number of slots per subframe. A slot is 1 ms for 15 kHz, 500 μs for 30 kHz, and so on. The subcarrier spacing of 15 kHz may occupy one slot per subframe, whereas the subcarrier spacing of 30 kHz may occupy two slots per subframe, and so on. Each slot may occupy either 14 OFDM symbols or 12 OFDM symbols, depending on the normal cyclic prefix (CP) or extended CP, respectively.

It should be noted that even though for the remainder of this disclosure, a 14-symbol configuration that is based on a normal CP is discussed, a 12-symbol configuration that is based on an extended CP may not be precluded from the solution space.

In 5G, a resource element (RE) is the smallest physical resource in NR which may include one subcarrier during one OFDM symbol. Also, in 5G, one NR Resource Block (RB) may contain 12 subcarriers in the frequency domain, irrespective of the numerology, and is defined only in the frequency domain (e.g., the bandwidth may not be fixed and may be dependent upon the configured subcarrier spacing). Additionally, in 5G, Physical Resource Blocks (PRBs) are the RBs that are used for actual/physical transmission/reception.

### NR Numerology

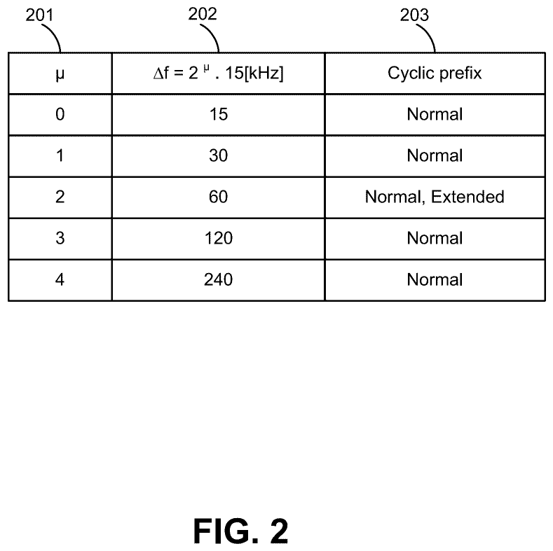

Numerology is a term used in the 3GPP specification to describe the different subcarrier spacing types. FIG. 2 is a diagram illustrating parameters related to subcarrier spacing (SCS), according to an example implementation of the present disclosure. The figure shows several different types of subcarrier spacing (which are similar to the Table 4.2-1 in TS 38.211) that defines the supported transmission numerologies. With reference to FIG. 2, Δf 202 is subcarrier spacing. The subcarrier spacing configuration μ 201 and the cyclic prefix 203 for a downlink or uplink bandwidth part may be obtained from the higher-layer parameters subcarrierSpacing and cyclicPrefix, respectively.

It should be noted that for the remainder of this disclosure, the terms numerology and SCS may be used interchangeably. It should also be noted that the term “SCS configuration factor n” may be used to refer to a subcarrier spacing type, where n may belong to the set [0,1,2,3,4], as noted in the table of FIG. 2 and is referred to as [symbol] 201.

### ENERGY HARVESTING LIMITATIONS OF AN AIOT DEVICE

As identified by the 5GS, (e.g., by section 5.2.1 of TS22.369), communication between 5G network/Ambient IoT capable UE and Ambient IoT devices may include periodic sensor reporting or network-initiated inventory. The communication between an AIoT device and the network may be driven by events (e.g., mobile originated messaging) at the device or by events (e.g., mobile terminated messaging) at the BS (e.g., the gNB). In either case, it is not expected that there may be any coordination between the device originated messaging and the network originated messaging. Therefore, it may be assumed that the duration between any two-message traffic is nondeterministic.

It is expected that the period at which the network (or other device capable of transmitting/receiving AIoT communications) may attempt to communicate with an AIoT device maybe a function of the network's needs to access an AIoT device for the purposes such as, sending the device configuration data (e.g. data controlling the device's operation), sending the device user data (e.g., data controlling the operation of sensors on the device), acquiring from the device the device's operational data (e.g., device status data), or acquiring from the device the device's user data (e.g., sensor output data) or all of the above.

It is also expected that that the period at which an AIoT device may attempt to communicate with the network (or other device capable of transmitting/receiving AIoT communications) may be a function of at least two aspects related to the AIoT device's operation. The first aspect may be the AIoT device's need to access the network for the purposes of sending the device status data (e.g. data representing the device's operation), sending the device user data (e.g. data representing the operation of sensors on the device), acquiring from the network the device's operational data (e.g., device configuration data), or acquiring from the network the device's user data (e.g., sensor configuration data) or all of the above.

The second aspect may be that the AIoT device having sufficient energy available to operate its transmitter/receiver/processor for a certain period of time (e.g. one complete data object transmission) and at a certain transmitter power level, such as TxMin. Where TxMin is the minimum power at which a wireless terminal transmits a symbol such that a wireless terminal that receives the symbol may exceed a signal detection threshold for correctly decoding the symbol. It should be noted that the term “certain transmitter power level”, is used herein to indicate the output power level of the device's transmitter, when averaged over the duration of time and frequency resources used to transport a message output by the device.

The energy used to operate an AIoT device may be derived (e.g., harvested) from the environment in which the device is operating. As the environmentally derived energy source may be intermittent, and generally outside of the control of the AIoT device, the opportunities for the device to harvest energy from the environment is generally nondeterministic between any two-energy harvesting opportunities. As the duration of the environmentally derived energy source may be brief, the quantity of energy harvested may be minimal.

Therefore, for each brief and intermittent energy harvesting opportunity, the AIoT device may only be able to acquire a fraction of the energy necessary to facilitate the successful transmission of one complete data object at a certain transmitter power level. Therefore, to accumulate sufficient energy as necessary to facilitate the successful transmission of one complete data object at a certain transmitter power level, the AIoT device may store the harvested energy from each energy harvesting opportunity into an energy storing device such as a capacitor.

Once the AIoT device has stored sufficient energy in its capacitor to facilitate the transmission of one complete data object at a certain transmitter power level, the AIoT device may be capable of establishing a communication channel with a BS, such as a gNB, (e.g., to respond to requests from a gNB to establish communication or originate a communication with the gNB). However, such communications may result in the AIoT device using nearly all the energy available in the capacitor to accomplish the transmission of the at least one complete data object at a certain transmitter power level.

If the AIoT device were to use nearly all the energy available in the capacitor (e.g. after transmitting at least one complete data object at a certain transmitter power level), the AIoT device's reserve energy capacity maybe such that the AIoT device may not be able to transmit another data object at a certain transmitter power level until the energy stored in the capacitor is restored to a threshold that may be sufficient to facilitate a complete transmission of at least one data object at a certain transmitter power level.

### Random Access Procedures Including Contention Based Random Access (CBRA)

Data and physical channels' messages are exchanged between an AIoT reader and an ambient IoT (AIoT) device. A PRDCH (Physical Random Downlink Control Channel) is a physical channel from reader to device, and a PDRCH is a physical channel from device to reader. A preamble is transmitted immediately preceding the transmission of a physical channel, i.e. a PDRCH or a PRDCH. The preamble is used for timing and clock acquisition. No separate start indication is needed. Clock-acquisition part provides at least the chip synchronization of the subsequent physical channel transmission

A paging message is the first message from an AIoT reader to initiate any AIoT initial access or data transmission. Different paging functions may be defined for unicast, broadcast, group cast and multicast, etc. At least a 2-step and a 3-step random access procedures should be supported.

### 2-Step Random Access Procedure

A 2-step random access (RA) may be used for “inventory only” cases with the following procedure. The RA procedure follows a paging message, starts from the Msg1 PDRCH from an AIoT device. If the paging step is counted into the RA procedure, the 2-step RA will become a 3-step RA instead.

AIoT paging is the first message before a random access procedure.

For contention based random access (CBRA), a 2-step CBRA paging message Msg0 PRDCH is transmitted by the reader with necessary random access resource information, e.g. the random access occasion (RO) size and time and frequency locations. The details of the paging message are not included in this disclosure.

The random access procedure is for device ID transmission from an AIoT device to the reader.

In a 2-step RA, an upper layer data, e.g. the actual device ID can be reported in Msg1. The actual ID size may be specified, e.g. 48-bit, 64-bit, 128 bit etc., and the ID may be unique for every AIoT device. The actual ID may be the device identification number and/or other information, e.g. serial number, model number etc. The actual ID size in Msg1 may be indicated by the Msg0 paging message.

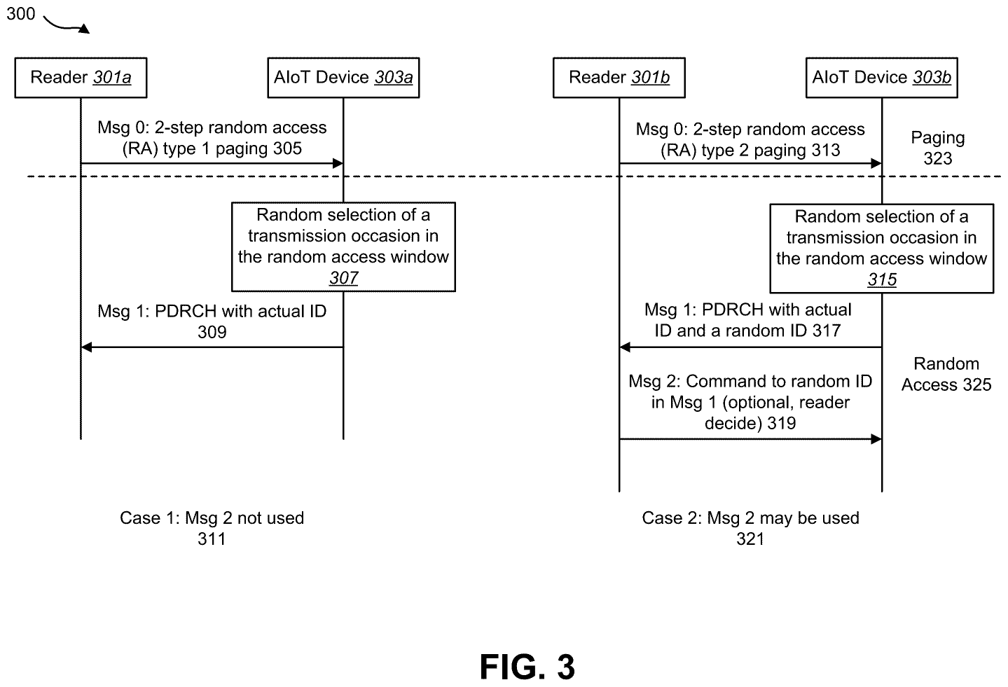

Msg1 is sent with contention if CBRA is configured, or without contention if contention free RA (CFRA) is configured. As shown in FIG. 3, for CBRA, a PDRCH Msg1 309 is transmitted from an AIoT device 303a to the reader 301a following a contention based random access 325 with slotted AIoT with contention slots and contention region provided in the paging 323 Msg0 305. A contention slot is also known as a random access occasion (RO) slot, or a transmission occasion (TO) slot, or a contention access unit, etc.

FIG. 3 is a diagram 300 illustrating examples of 2-step contention-based random access procedures and cases. Two types of 2-step RA may be specified. In one type, i.e. a Type 1 2-step RA procedure, an AIoT device 303a sends a Msg1 PDRCH 309 following the paging 323 Msg0 305. After Msg0 305, the AIoT device 303a may perform a random selection of a transmission occasion in the random access window 307. The actual ID and/or other upper layer data may be included in the Msg1 309. In another type, i.e. a Type 2 2-step RA procedure, a random ID (fixed 16bits) may be included together with the actual ID and/or other upper layer data in AIoT Msg1 317.

Thus, in a 2-step RA, Msg2 319 may be supported. Whether it is needed it is up to the reader. FIG. 3 shows two cases with and without Msg2 319. In case 1 311, Msg2 is not used, and only an actual ID is included in Msg1 309. In Case 2 321, for 2-step CBRA when Msg2 319 is needed, a random ID (fixed 16bits) may be also included besides the upper layer data (e.g. the actual ID) in AIoT 303b Msg1 317, and is echoed in AIoT 303b Msg2 319. The random ID is generated randomly in a defined 16-bit space. Thus, both a random ID and an actual ID can be reported together. The random ID or temporary ID may be 16-bit. Case 2 321 may also include Msg0 313, which is sent from the reader 301b to the AIoT device 303b. After Msg0 313, the AIoT device 303b may perform a random selection of a transmission occasion in the random access window 315.

Msg2 319 is a PRDCH from the reader 301b to the AIoT device 303b to confirm the reception of Msg1 317 by addressing to the random ID in Msg1 317. Since random ID is only 16-bit and much shorter than the actual ID, the Msg2 319 size can be reduced.

Alternatively or additionally, Msg2 319 may address to the actual ID to confirm the reception of Msg1 317. Since the actual ID is unique to every device, this can avoid the collision case when two devices sent the same random ID. Moreover, the use of actual ID in Msg2 319 may remove the need of including the random ID in Msg1 317. Thus, the Msg1 size and the RO slot size may be reduced.

### 3-Step Random Access Procedure

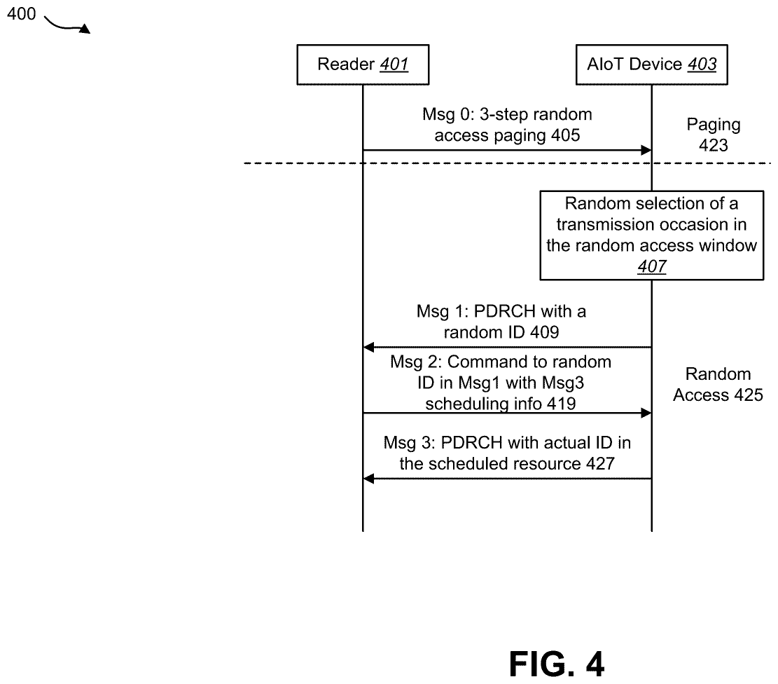

FIG. 4 is a diagram 400 demonstrating a 3-step random access 425 which may be used for “inventory and command” case with the following procedure. The RA procedure follows a paging 423 message, starts from the Msg1 PDRCH 409 from an AIoT device 403. If the paging step is counted into the RA procedure, the 3-step RA will become a 4-step RA instead.

AIoT paging 423 is the first message before a random access procedure 425.

For contention based random access (CBRA), as shown in FIG. 4, a 3-step CBRA paging message Msg0 PRDCH 405 is transmitted by the reader 401 with necessary random access resource information, e.g. the random access occasion (RO) size and time and frequency locations. The details of the paging message are not included in this disclosure. After Msg0 405 is transmitted, the AIoT device 403 may perform a random selection of a transmission occasion in the random access window 407.

The random access procedure is for device ID transmission from an AIoT device 403 to the reader 401. For CBRA, a PDRCH Msg1 409 is transmitted from an AIoT device 403 to the reader 401 following a contention based random access with slotted AIoT with each contention slots and contention region provided in the paging Msg0 405.

In a 3-step RA, only a 16-bit random ID is included in Msg1 409. The actual ID or other upper layer data is not in Msg1 409. The random ID is generated randomly in a defined 16-bit space.

In a 3-step RA, a Msg2 419 is a PRDCH from the reader to the AIoT device 403 (e.g. the R2D command) by addressing to the random ID in Msg1 409. This echoes the reception of Msg1 409 to the AIoT device 403. Furthermore, Msg2 419 may include a PDRCH scheduling information to schedule a Msg3 427 transmission from the AIoT device 403. The R2D command may determine the information to be reported in Msg3 427, e.g. the actual ID, and/or some upper layer data, etc.

The AIoT device 403 may then follow the scheduling information in Msg2 419 to transmit Msg3 PDRCH 427, i.e. the corresponding device to reader data transmission (e.g. the feedback). Msg3 427 may contain at least the actual ID of the device, and other data if requested in Msg2 419.

The actual ID size may be specified, e.g. 48-bit, 64-bit, 128 bit etc., and the ID may be unique for every AIoT device 403. The actual ID may be the device identification number and/or other information, e.g. serial number, model number etc. The actual ID size in Msg3 427 may be indicated in the Msg2 419.

### Problems in CBRA With Duplicate Paging Messages

AIoT systems support mechanisms for readers to be able to trigger multiple/subsequent AIoT paging messages that are associated with the same request from the core network (CN). For example, an AIoT reader may need to send multiple paging messages to collect more feedback from AIoT devices. The reader may need to cover different directions for the same paging message. Therefore:
Some mechanisms should be defined to identify whether a paging Msg0 is a new paging process or a duplicate/re-transmission of an ongoing paging process.
On the other hand, the AIoT devices should try to avoid duplicated responses for the same paging process. How to determine whether a Msg1 transmission is needed based on the paging message should be further defined.
Furthermore, some D2R messages are not acknowledged in the RA procedures, e, g, a Msg1 in a 2-step CBRA without Msg2, and a Msg3 in 3-step CBRA. How to handle collision/lost cases, and how to perform failure/success indication of D2R transmissions should be studied.

### Embodiment 1: Indication and Detection of New or Duplicate Paging Messages

For multiple paging messages for the same paging process, the first problem is to indicate the duplicate paging message by the reader 401, and the duplicate detection at AIoT devices (403, 303).

For contention free paging, the reader 401 sends a direct message to a target AIoT device 403 with scheduling information for Msg1 409. The AIoT device 403 sends Msg1 PDRCH 409 without contention, thus no collision will occur. If the Msg1 409 is not received in the scheduled resource, the reader 401 can send another paging message 423 to the target device.

In NR, the PRACH resources and random access occasions are configured. For CBRA, a UE sends a preamble in a random access occasion, and waits for an random access response (RAR) to confirm the preamble reception at the gNB. In NR, paging functions are mostly for Triggering RRC Setup (RRC Request and RRC Connection Resumption). Paging 423 is the mechanism in which the network tells a specific UE that there is some data for it. Then the UE decodes the content of the paging message and the UE has to initiate the appropriate the procedure. Thus, the UE identity is known and indicated in the paging message.

In AIoT, CBRA based paging, the AIoT device 403 identities are not known at the reader 401. The reader 401 sends a paging message to trigger the ID reporting from the AIoT devices. The paging message (Msg0 405) should indicate whether the paging is a broadcast or groupcast contention based random access paging, and whether a 2-step or 3-step RA procedures is used.

In AIoT CBRA, the contention random access resources, i.e. random access occasions (ROs), or transmission occasions (TO), are dynamically scheduled in Msg0 405. An AIoT device 403 then performs CBRA to send Msg1 409 to the reader 401. The reader 401 detects Msg1 409 from AIoT devices in each RO with three possible outcomes.
A RO or contention access slot is empty: no Msg1 409 transmission detected at the reader
Successfully receive and decode a Msg1 409 from an AIoT device
Failed to decode a Msg1 409 due to Msg1 collision or bad channel conditions

From the AIoT device 403 point of view, an AIoT device may mis-detect some of the paging messages. The contention access from AIoT devices may cause collision or mis-detection at the reader 401. An AIoT device may not have enough energy to send a message. On the other hand, if an AIoT device responds to every paging message, unnecessary contention and collision may occur.

An AIoT reader 401 may send multiple paging messages to collect feedback from AIoT devices (403, 303). Thus, some information or indication should be included in paging PRDCH Msg0 405 for the paging identification. Based on the information, an A-IoT device 403 should determine whether a paging message is for the same paging process or not to prevent duplicate transmissions and to reduce potential collisions.

A paging ID can be included in a paging PRDCH Msg0 405. A paging ID size may be specified, e.g. 4, 8 or 16 bits, etc.
In one method, paging ID can be increased by one for each new paging process. The paging IDs are reused cyclically based on the ID spaces. This prevents the same ID to be used with in cyclic space.
In another method, the paging ID of a new paging process can be randomly selected in the ID space. The random ID should avoid the same IDs that are used in a period, i.e. the paging IDs used in the previous period should be excluded from the random ID selection. The period can be specified or fixed, e.g. 1 minute, 5 mins, 10 mins etc.

If there are multiple AIoT readers, it is possible more than one reader may select the same paging ID at the same time and cause paging ID collision. If the paging ID is big enough, the collision probability may be small.

To avoid the ambiguity of paging from different readers, additionally, an AIoT reader ID may be included in the paging RDCH Msg0 405 together with the paging ID. A reader ID size may be specified, e.g. 4, 8 or 16 bits, etc. The reader ID may be pre-configured and unique for a reader. The reader ID may be randomly selected in the ID space by the reader. The reader 401 may scan the area for any other readers to avoid using the same reader ID in its paging messages.

The combination of paging ID and reader ID may define a unique paging process. An AIoT device 403 can differentiate a different paging process from different readers as well.

Additionally or alternatively, a paging re-transmission counter may be included with the paging PRDCH Msg0 405 for a given paging ID. A maximum number of retransmissions may be specified or configured for a reader. The reader may re-transmission the same paging message with the same paging ID up to the maximum number of retransmissions. The paging re-transmission counter is reset to 0 for each new paging process with a new paging ID, and increased by 1 for each paging message re-transmission for the same paging ID. Alternatively, the paging retransmission counter may be maintained at the reader 401 without reporting the actual value. The retransmission indication can be 1 bit only, 0 for initial transmission and 1 for retransmission. Or vice versa, thus a new paging is indicated with a bit 1, and a bit 0 means same paging message re-transmission.

An AIoT device 403 may determine the paging message is a re-transmission of an existing paging process by the paging counter. If the counter is 0, the paging Msg0 405 is a new paging message, and if the counter is greater than 0, the paging message is a re-transmission of the same paging process. Furthermore, the AIoT device 403 may determine whether one or more paging messages is(are) not detected by detecting whether some paging counters are missed.

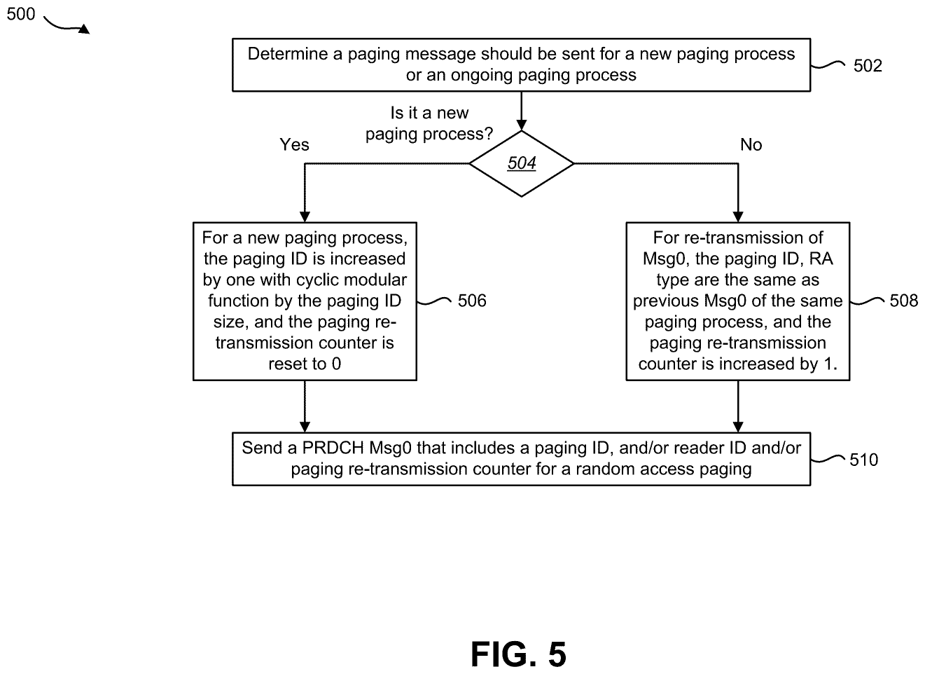

FIG. 5 is a flow diagram illustrating a method 500 by an AIoT reader. The method illustrates AIoT reader behavior for paging Msg0 retransmission. The AIoT reader may determine 502 a paging message should be sent for a new paging process or an ongoing paging process. The reader then determines 504 whether it is a new paging process. For a new paging process 506, the paging ID is increased by one with cyclic modular function by the paging ID size, and the paging re-transmission counter is reset to 0. If it is not a new paging process, for re-transmission of Msg0 508, the paging ID, RA type are the same as previous Msg0 of the same paging process, and the paging re-transmission counter is increased by 1. Next, the reader may send 510 a PRDCH Msg0 that includes a paging ID, and/or reader ID and/or paging re-transmission counter and a type of random access, etc. for random access paging.
The type of random access can be 2-step or 3-step, and a 2-step may or may not use Msg2.
The combination of paging ID and reader ID defines a paging process.
For re-transmission of Msg0:
   The type of random access type paging ID are the same as previous Msg0 of the same paging process, and the paging re-transmission counter is increased by 1.
   A maximum number of paging retransmissions may be configured or specified. No transmission if the maximum number of retransmissions is reached.

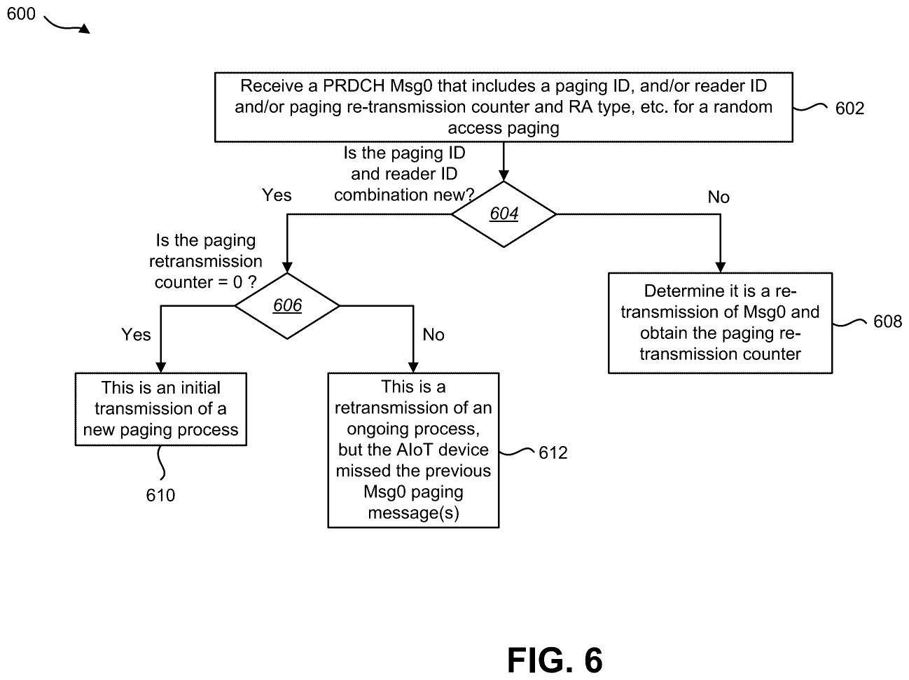

FIG. 6 is a flow diagram illustrating a method 600 by an AIoT device. FIG. 6 provides the AIoT device behavior for determining whether a received paging Msg0 is a new paging process or retransmission of an ongoing paging process. The AIoT device may receive 602 a PRDCH Msg0 that includes a paging ID, and/or reader ID and/or paging re-transmission counter and RA type, etc. for a random access paging. The device then determines 604 whether the paging ID and reader ID is a new combination. If it is a new combination, the device then determines 606 if the paging retransmission counter equals 0. But if the paging ID and reader ID combination is not new, the device determines 608 that it is a re-transmission of Msg0 and obtains the paging re-transmission counter. If the paging retransmission counter is 0, the AIoT device determines 610 that this is an initial transmission of a new paging process. If the paging retransmission counter does not equal 0, the device determines 612 that this is a retransmission of an ongoing process, but the AIoT device missed the previous Msg0 paging message(s).
The type of random access can be 2-step or 3-step, and a 2-step may or may not use Msg2.
The combination of paging ID and reader ID defines a paging process.
Determine the paging type and RA type of the paging, and whether the paging Msg0 is a duplicate of an ongoing paging process or a new paging process.
The AIoT determines that the paging is a new paging, if the paging ID and reader ID combination is new to the AIoT device. Several cases are included:
   If the paging retransmission counter is 0, the AIoT determines that the paging is a new initial paging.
   If the paging retransmission counter is greater than 0, the AIoT determines that the paging is a paging process with missed previous paging messages.
The AIoT determines that the paging is a duplicate paging of an ongoing paging process if the paging ID and reader ID combination is known to the AIoT device and the retransmission counter is greater than 0.

### Embodiment 2: Conditions to Transmit a Duplicate Paging Message by the Reader

An AIoT reader may need to send multiple paging messages for the same paging process. The conditions on triggering the paging message retransmission should be specified. The reader may decide to retransmit Msg0 for a variety of reasons.

For CBRA, a RO in a contention access region, the reader listens to the channel for Msg1 reception and may have three possible observations and reception status:
Successfully receive and decode a Msg1 with a random/actual ID
Detect energy with Msg 1 transmissions, but cannot decode anything successfully. Thus implies a collision of Msg1 occurs, i.e. more than one AIoT devices transmit Msg1 in the same RO.
Idle. No energy detected in the RO, i.e. no AIoT device selects this RO for Msg1 transmission.

The status of each RO in the contention access region can be observed and obtained at the reader. And the reader can determine whether a duplicate paging message should be transmitted for the same paging process or a new paging process should be initiated.

In some cases, the reader has to resend the Msg0 to resolve collision if collision is detected in a RO, or random ID collision is observed among the detected Msg1s in different ROs. The detailed cases may include at least the following:
Case 1: The reader may detect collisions in one or more ROs, so a new Msg0 will allow the AIoT devices involved in the collision to retransmit with collision resolution. In this case, the AIoT devices may use the same random ID or regenerate a new random ID as the random ID is not detected by the reader anyway.
Case 2: The reader may detect more than one AIoT devices reported the same random ID. Thus, a new Msg0 will allow these devices to retransmit with new random ID for collision resolution. If AIoT devices always keep the same random ID, this issue may not be solved, so the reader needs to start a new paging process instead.
Case 3: The reader may expect more AIoT responses, e.g. if there are still AIoT devices sending Msg1 in the previous random access region.
Case 4: The reader may send multiple paging messages at different directions to cover more AIoT devices, etc.

The AIoT reader behavior may be summarized as follows:
The reader sends a PRDCH Msg0 that includes a paging ID, and/or reader ID and/or paging re-transmission counter for a random access paging.
The reader receives Msg1s from AIoT devices in the contention access region and evaluates the Msg1 detection results, and determines whether a duplicate Msg0 transmission is needed.
A reader should send a duplicate paging message, i.e. retransmit a Msg0 at least in the following conditions:
   Case 1: The reader may detect collisions in one or more ROs, so a new Msg0 will allow the AIoT devices involved in the collision to retransmit with collision resolution.
   Case 2: The reader may detect more than one AIoT devices reported the same random ID. Thus, a new Msg0 will allow these devices to retransmit with new random ID for collision resolution.
   Case 3: The reader may expect more AIoT responses, e.g. if there are still AIoT devices sending Msg1 in the previous random access region.
If all ROs in the previous contention access region are detected as successful or idle, i.e. no collision detected, and no random ID collision, the reader should stop the paging process. Thus, no duplication Msg0 retransmission again for the paging process.
On the other hand, even if no collision detected in a contention access region, the reader may expect more AIoT responses from the paging process, e.g. the random access algorithms do not require all AIoT devices transmit Msg1 after the detection of Msg0; or some AIoT devices do not have enough energy to transmit Msg1 after the previous paging, etc. In this case, the reader may still re=transmit the paging message for the same paging process to check if there are any remaining AIoT devices in the paging area.

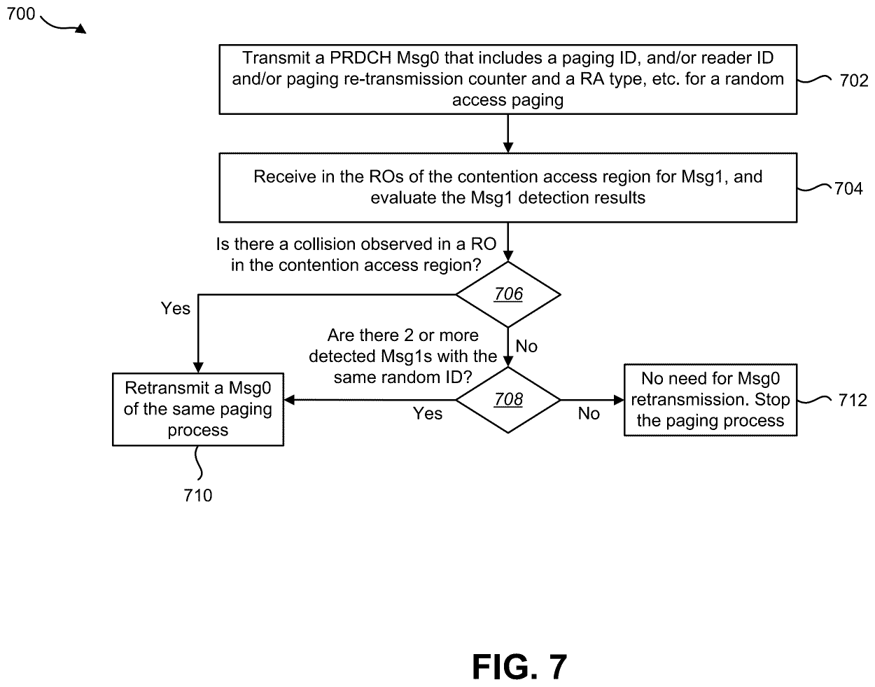

FIG. 7 is a flow diagram illustrating a method 700 by an AIoT reader. The reader may transmit 702 a PRDCH Msg0 that includes a paging ID, and/or reader ID and/or paging re-transmission counter and a RA type, etc. for a random access paging. The reader may receive 704 in the ROs of the contention access region for Msg1, and evaluate the Msg1 detection results. The reader then determines 706 whether there is a collision observed in a RO in the contention access region. If there is a collision, the reader may retransmit 710 a Msg0 of the same paging process. If there isn't a collision, the reader then determines 708 if there are two or more detected Msg1s with the same random ID. If there are two or more detected Msg1s, the reader may retransmit 710 a Msg0 of the same paging process. If there are not more than 2 detected Msg1s, there's no need for Msg0 retransmission and the reader may stop 712 the paging process.

### Embodiment 3: Energy Status Report in Random Access Procedure for Ambient IoT

This embodiment discloses a method and apparatus for an AIoT device to report its energy status to a reader. In some examples, an energy harvesting electronic device includes an energy storage device and a processor that is configured to receive a first message from another electronic device requesting the transmission of a first data object and determine a first amount of energy required for transmitting the first data object and a second amount of energy required for receiving a second message from the other electronic device. After determining that the amount of stored energy is sufficient for transmitting the first data object, the processor determines, based on the second amount of energy, whether the remaining amount of energy after transmitting the first object is sufficient for receiving the second message, sets an indicator to indicate whether or not the remaining amount of energy stored in the energy storage device after transmitting the first object is sufficient, and transmits the first data object and the indicator to the other electronic device.

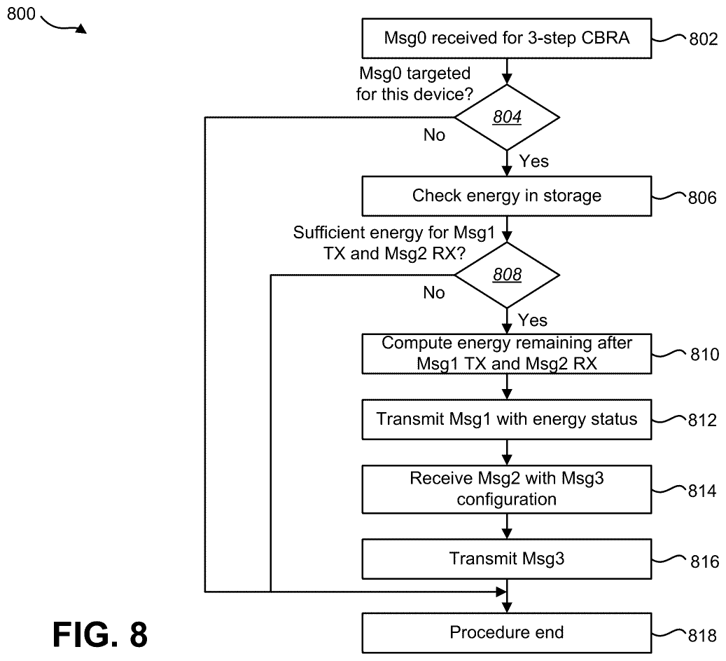

The present systems and methods are aimed to apply the basic concepts disclosed above to the random access procedure for AIoT devices described in Embodiment 1, specifically, to the 3-step contention based random access procedure shown in FIG. 4. Upon receiving the Msg0 405 (AIoT paging), the AoT device 403 of this embodiment may determine if the amount of stored energy is sufficient to continue the random access procedure. An example operation of the 3-step contention based random access procedure for the AIoT device is illustrated in FIG. 8.

FIG. 8 is a flow diagram illustrating a method 800 by an AIoT device. The device may receive 802 Msg0 (AIoT paging) from the reader. The Msg0 may include an indication indicating 3-step contention based random access, one or more AIoT device IDs, one or more random access occasions (ROs) for Msg1 transmission and other configuration parameters to configure the Msg1 transmission, such as preamble sequence configurations and transmit power configurations.

The device may check 804 if the Msg0 is targeted for this AIoT device. The check may be performed by comparing the ID of this AIoT device and the one or more AIoT device IDs in the Msg0. If at least one of the one or more AIoT device IDs match the ID of this AIoT device, proceed to step 806, otherwise the random access procedure ends 818. Next, the device may check 806 the amount of energy currently stored in the energy storage.

The device may determine 808 if the amount of energy derived at 806 is sufficient for transmission of the Msg1 and subsequent reception of Msg2. In one implementation, the determination may be performed based on the Msg1 configuration parameters received in the Msg0. If the determination results in positive, proceed to 810, otherwise the random access procedure ends 818. The device may compute 810 the estimate of energy remaining in the energy storage after the Msg1 transmission and the subsequent Msg2 reception.

The device may transmit 812, to the reader, the Msg1 with energy status on one of the ROs configured in Msg0. The other configuration parameters configured in the Msg0 may be also used for the Msg1 transmission. The Msg1 may comprise energy status and may further comprise a random ID disclosed in Embodiment 1 (e.g., 16-bit random number generated by this AIoT device). The energy status is information related to the estimate of energy computed at 810.

The device may receive 814, from the reader, Msg2 with Msg3 configuration as a response to the Msg1. The Msg2 may comprise the random ID echoing the random ID in the Msg1. The Msg2 may further comprise configuration parameters for the subsequent Msg3 transmission at 816, including but not limited to, time-frequency resource(s) assigned to the AIoT device for the Msg3 transmission, Msg3 coding/modulation scheme(s), Msg3 transmit power and other parameters.

The device may transmit 816 the Msg3 on the time-frequency resource(s) assigned by the Msg2 received at 814. The Msg3 may comprise the actual ID and upper-layer data, as disclosed in Embodiment 1. Lastly, the 3-step contention-based random access procedure ends 818.

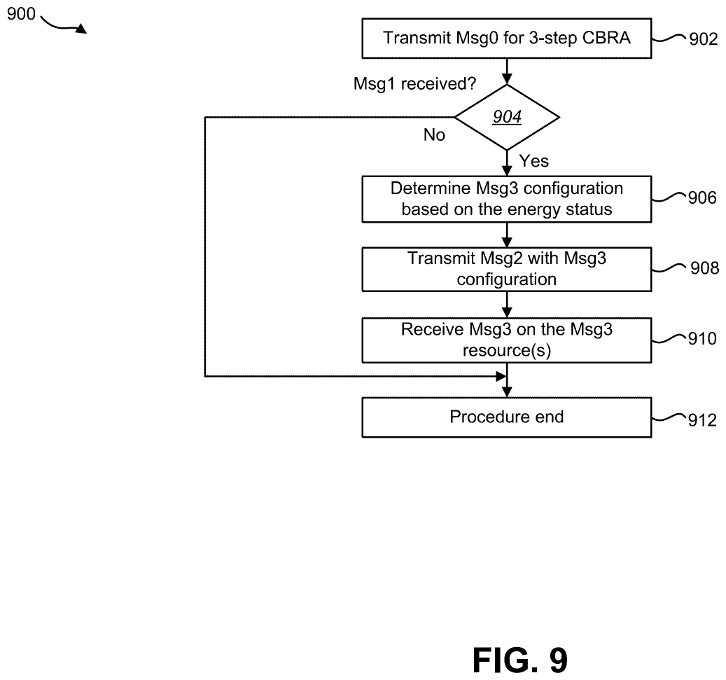

FIG. 9 is a flow diagram illustrating another method 900 by an AIoT reader. FIG. 9 illustrates an example operation of the reader performing the 3-step contention based random access procedure for the present embodiment.

The reader may initiate the 3-step contention based random access procedure by transmitting 902 the Msg0 to AIoT devices in the proximity of the reader. The Msg0 may include an indication indicating 3-step contention based random access, one or more AIoT device IDs, one or more random access occasions (ROs) for Msg1 transmission and other configuration parameters to configure the Msg1 transmission, such as preamble sequence configurations and transmit power configurations. The reader may wait and check if Msg1 from an AIoT device is received 904. If positive, proceed to step 906. The Msg1 may comprise energy status, and may further comprise a random ID disclosed in Embodiment 1 (e.g., 16-bit random number generated by this AIoT device). The energy status is computed by the AIoT device and may be an estimate of energy remaining in the energy storage of the AIoT after the Msg1 transmission and the subsequent Msg2 reception.

If the reader determines 904 that the Msg1 was not received, the procedure ends 912. If Msg1 from an AIoT device is received, the reader may determine 906 the Msg3 configuration based on the energy status. In other words, the reader may determine the configuration parameters of Msg3 transmission for the AIoT device that responded with the Msg1 received at step 906. The configuration parameters may include, but not limited to, time-frequency resource(s) assigned to the AIoT device for the Msg3 transmission, Msg3 coding/modulation scheme(s), Msg3 transmit power and other parameters. The determination of such configuration parameters may be based on the energy status reported in Msg1 (906). For example, if the reader considers, based on the energy status, that there will be sufficient energy for the AIoT device to transmit the Msg3, the configuration parameters of Msg3 transmission may be constructed in a normal manner. Otherwise, the configuration parameters of Msg3 transmission may be constructed as a “low energy” mode parameters, such as low coding/modulation scheme(s) and lower transmit power. Additionally or alternatively, for the low-energy mode, the reader may configure delayed timing for the time-frequency resource(s) of the Msg3, in order to provide more time to the AIoT device to harvest energy.

The reader may transmit 908 the Msg2 with the Msg3 configuration to the AIoT device. The Msg2 may comprise the random ID echoed to the random ID in the Msg1 and may further comprise the configuration parameters determined at 908.

The reader may wait and receive 910 Msg3 on the Msg3 resource(s) from the AIoT device. The Msg3 may comprise the actual ID of the AIoT device and upper-layer data, as disclosed in Embodiment 1. Lastly, the 3-step contention-based random access procedure ends 912.

The energy status generated by the AIoT device at step 812 of FIG. 8 may be based on the estimate of energy to be remaining in the energy storage after the Msg1 transmission and the subsequent Msg2 reception, computed in Step 810. In one implementation, the information may be a number representing remaining electric charge. In another implementation, the information may comprise a choice selected from multiple selections (such as “low”, “mid” and “high”) as a charging level. In yet another implementation, the information may comprise a gap (time duration) between the Msg2 reception and the Msg3 transmission. The gap may indicate that how much time the AIoT device will require to harvest ambient energy sufficient for the Msg3 transmission. If there will be enough energy estimated for the Msg3 transmission, i.e., the AIoT device is ready to transmit the Msg3 after the Msg2 reception without additional charging, the gap may be zero or not present in the energy status.

The reader may receive the energy status and use it for generating configuration parameters for the AIoT device's Msg3 transmission. For example, if the energy state represents the remaining electric charge, or the charging level, the reader, based on the energy status, may determine most suitable configuration parameters for the Msg3 transmission. If the energy state comprises the gap between the Msg2 and the Msg3, the reader may configure the time resource(s) of the Msg3 transmission to ensure that the AIoT device has sufficient time to collect ambient energy.

In one configuration, the Msg0 (paging message) may further comprise assistance information to be used for the energy status report in Msg1. For example, the assistance information may comprise several configuration options for the AIoT device to choose, wherein each of the configuration options may comprise one or more time windows for Msg3 ROs. One example implementation of the configuration options may be a set of minimum Msg2-Msg3 gaps, such as {“100 ms”, “200 ms”, “1 s”, “5 s”}. Upon reception of Msg0, the AIoT device may, based on the energy status, choose one of the minimum gaps (e.g., “1 s”) and include the index of its choice in the Msg1. Upon receiving the Msg1 with the index of the selected configuration option, such as “1 s”, the reader may configure the time-frequency resource(s) for Msg3 transmission to guarantee at least one second from the Msg2.

### Embodiment 4: Msg3 Transmission Capability Report in Random Access Procedure for Ambient IoT

For the operation disclosed in Embodiment 3, in some circumstances the AIoT device may not be able to complete the 3-step contention based random access procedure due to lack of stored energy. This present embodiment is aimed to disclose a method and apparatus for the random access procedure to accommodate with such circumstances, particularly the case where the AIoT can perform Msg1 transmission but cannot transmit Msg3.

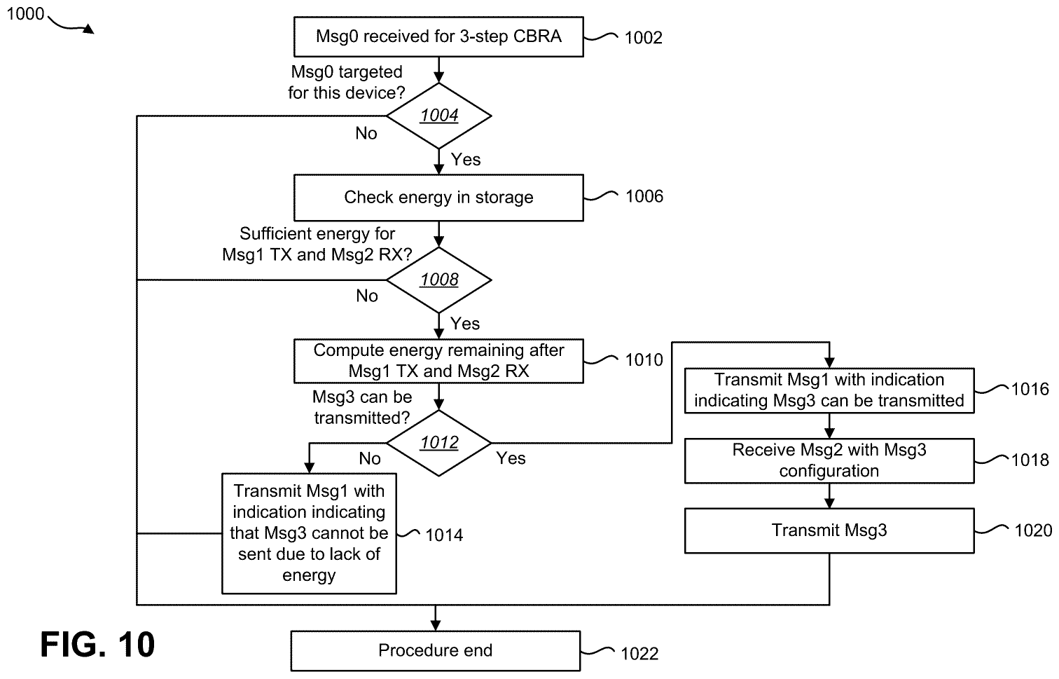

FIG. 10 is a flow diagram illustrating another method 1000 by an AIoT device. FIG. 10 illustrates an example operation of the present embodiment for the AIoT device. The device may receive 1002 Msg0 for the 3-step CBRA, then if it is determined 1004 that the Msg0 is targeted for this device, the device may check 1006 energy in storage. If Msg0 is not targeted for this device, the procedure ends 1022. If it is determined 1008 that there is sufficient energy for Msg1 TX and Msg2 RX, the device may compute 1010 the energy remaining after Msg1 TX and Msg2 RX. If there is not sufficient energy, the procedure ends 1022.

If it is determined 1012, based on the estimate of energy remaining in the energy storage computed at 1010, that the AIoT device will not be able to transmit the Msg3, the device will transmit 1014 Msg1 with indication indicating that Msg3 cannot be sent due to lack of energy and then the procedure will end 1022. If it is determined 1012 that the AIoT device will be able to transmit the Msg3, the device will transmit 1016 the Msg1, which comprises an indication indicating that the AIoT device will be able to transmit the Msg3. If positive (i.e., Msg3 can be transmitted), the Msg1 may also comprise the energy status disclosed in the previous embodiment (step 812 of FIG. 8), otherwise, the energy status may not be present in the Msg1. Next, the AIoT device will receive 1018 Msg2 with Msg3 configuration and then will transmit 1020 Msg3. Lastly, the 3-step contention-based random access procedure ends 1022.

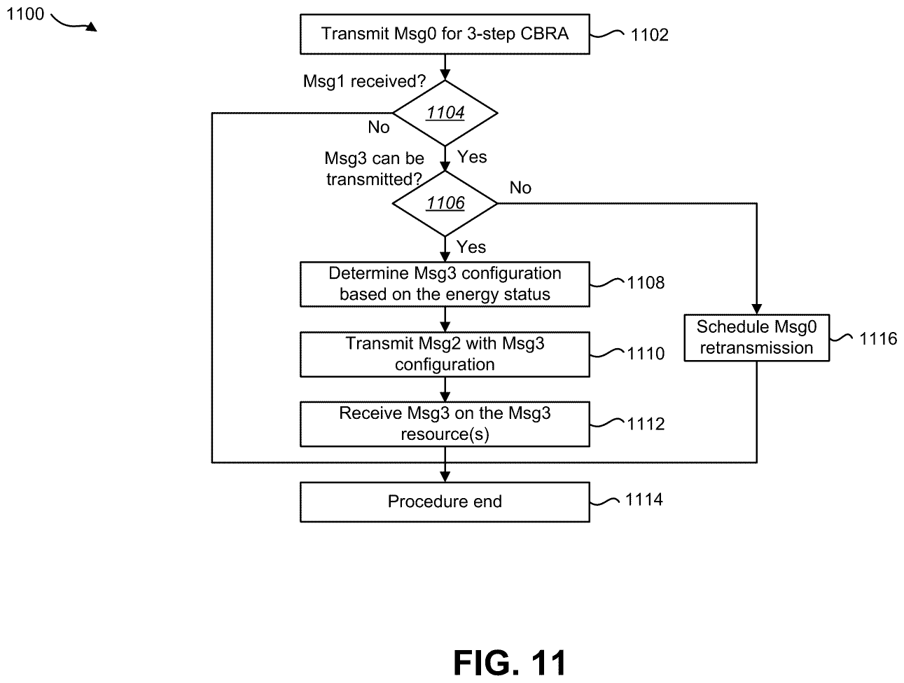

FIG. 11 is a flow diagram 1100 illustrating a method by an AIoT reader. FIG. 11 illustrates an example operation of the present embodiment for the reader. The reader may transmit 1102 Msg0 for 3-step CBRA then determine 1104 if Msg1 was received. It if wasn't received, the procedure ends 1114. Next, the reader will determine 1106 if Msg3 can be transmitted. If it cannot be transmitted, the reader will schedule 1116 Msg0 retransmission and then the procedure will end 1114. If the Msg3 can be transmitted, the reader will determine 1108 the Msg3 configuration based on the energy status. Next, the reader may transmit 1110 Msg2 with Msg3 configuration and then receive 1112 Msg3 on the Msg3 resource(s) and finally, the procedure ends 1114.

At step 1012 of FIG. 10, the AIoT device may consider additional conditions to determine the possibility of subsequent Msg3 transmission. For example, the AIoT may have knowledge of an energy harvesting rate under the current environmental condition and may be able to figure out if it is likely to collect energy sufficient for Msg3 within a time duration. This time duration may be a maximum Msg2-Msg3 gap allowed for the AIoT device, which may be pre-configured to the AIoT device, a pre-determined value, or configured by the reader (e.g., configured by Msg0). If the AIoT considers that the energy harvesting for Msg3 will be completed within the maximum gap, or no more energy harvesting is needed (sufficient energy already stored in the energy storage), the AIoT device may consider that the Msg3 can be transmitted, which may be indicated in the Msg1 at step 1016.

At step 1016, in one implementation, the indication indicating that the AIoT device will be able to transmit the Msg3 and is the energy status may be separate data fields. In another implementation, the indication may be expressed by presence or absence of the energy status data field.

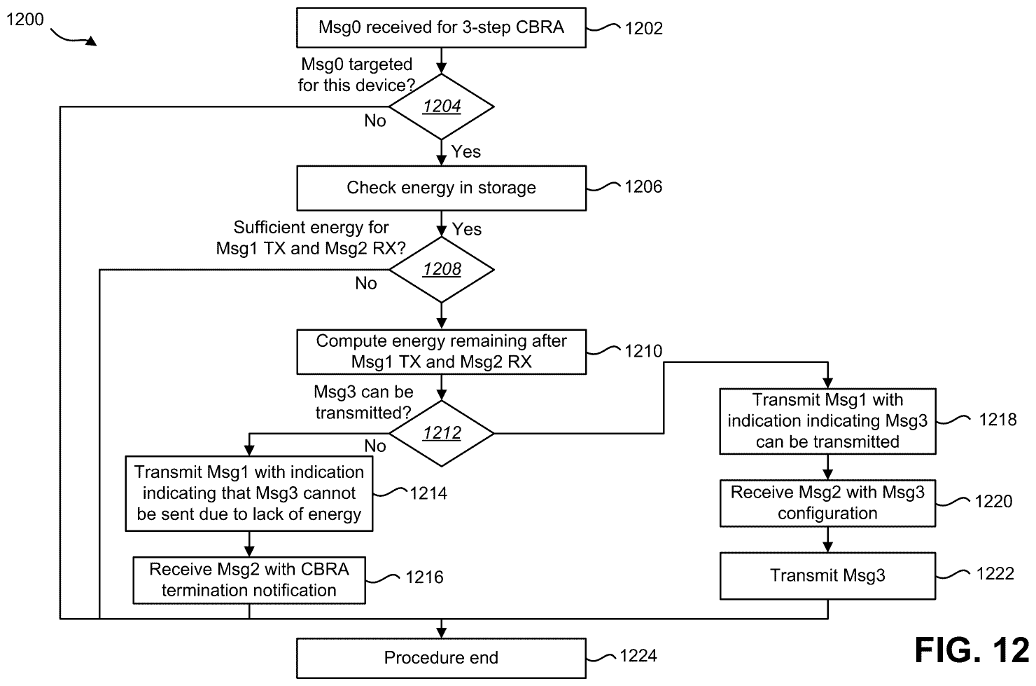

FIG. 12 is a flow diagram 1200 illustrating the present embodiment for the AIoT device, which is identical to the operation of FIG. 10, except one additional operational step, 1216, wherein the AIoT device may receive the Msg2 from the reader. The Msg2 may include, in addition to the random ID echoing that of the Msg1, a notification that the current 3-step contention-based random-access procedure is terminated unsuccessfully. The Msg2 of step 1216 may not include the Msg3 configuration that may be comprised in the Msg2 of step 1220. The Msg2 of step 1216 may further comprise information for scheduled Msg0 retransmission.

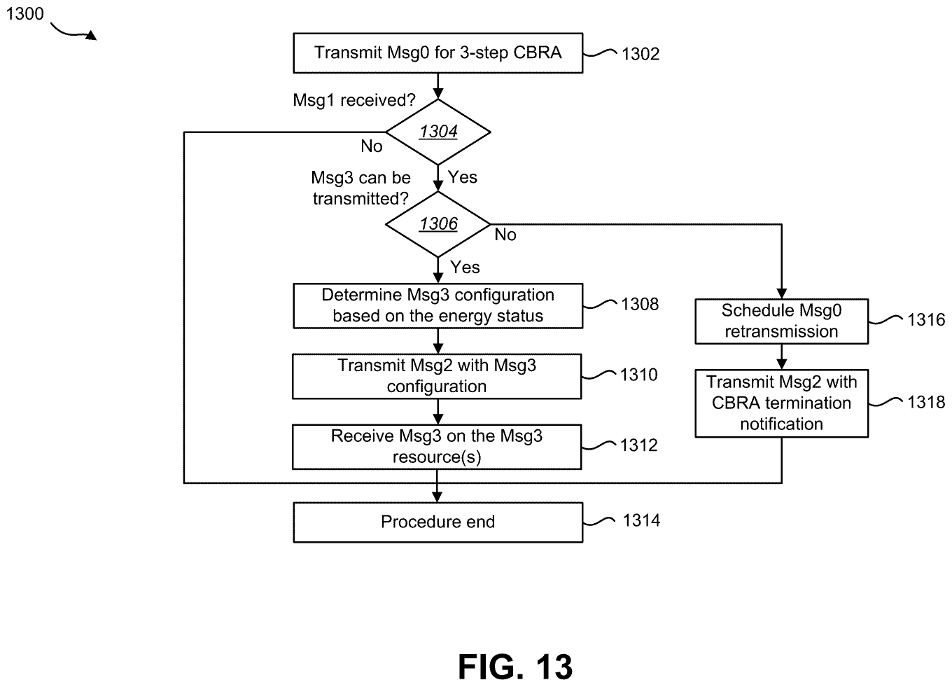

FIG. 13 is a flow diagram 1300 illustrating an example operation for the reader corresponding to FIG. 12, which is identical to the operation of FIG. 11, except one additional operational step, 1318, wherein the reader may transmit, as a response to the Msg1 in step 1304, the Msg2. The Msg2 may include, in addition to the random ID echoing that of the Msg1, a notification that the current 3-step contention-based random access procedure is terminated unsuccessfully. The Msg2 of step 1318 may not include the Msg3 configuration that may be comprised in the Msg2 of step 1312. The Msg2 of step 1318 may further comprise information for scheduled Msg0 retransmission.

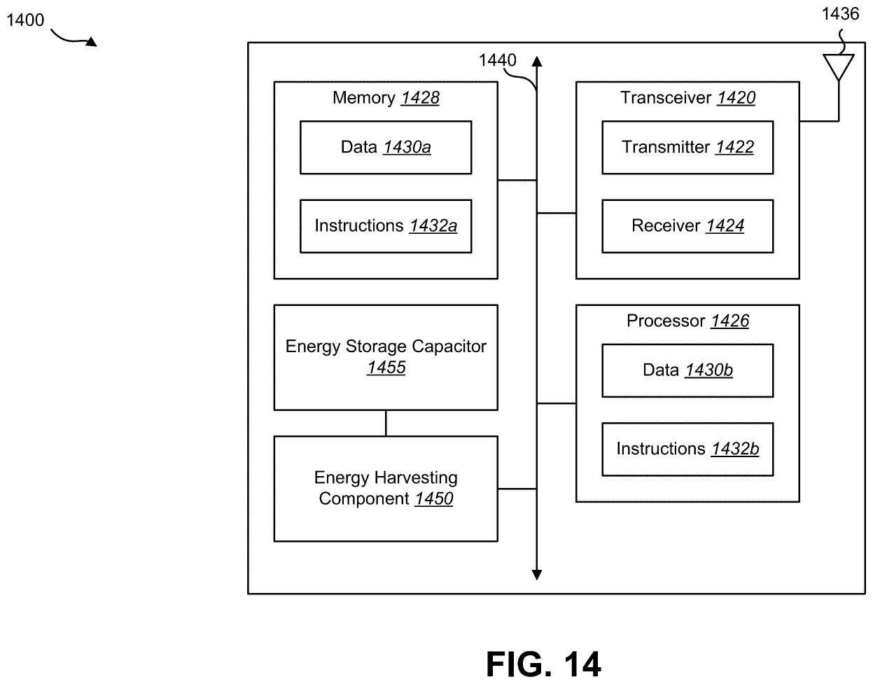

FIG. 14 illustrates a block diagram of an energy harvesting node 1400 for wireless communication according to an example implementation of the present disclosure. The node 1400 may, for example, be an AIoT, such as the wireless terminals 101-104 of FIG. 1.

As shown in FIG. 14, the node 1400 may include a transceiver 1420, a processor 1426, a memory 1428, at least one antenna 1436, an energy harvesting component 1450, and an energy storage capacitor 1455. The node 1400 may also include an RF spectrum band module, a base station communications module, a network communications module, and a system communications management module, input/output (I/O) ports, I/O components, and power supply (not explicitly shown in FIG. 14). Each of these components may be in communication with each other, directly or indirectly, over one or more buses 1440.

The transceiver 1420 having the transmitter 1422 and the receiver 1424 may be configured to transmit and/or receive time and/or frequency resource partitioning information. In some implementations, the transceiver 1420 may be configured to transmit in different types of subframes and slots including, but not limited to, usable, non-usable, and flexibly usable subframes and slot formats. The transceiver 1420 may be configured to receive data and control signaling.

The node 1400 may include a variety of computer-readable media. Computer-readable media may be any available media that may be accessed by node 1400 and include both volatile and non-volatile media, removable and non-removable media. By way of example, and not limitation, computer-readable media may include computer storage media and communication media. Computer storage media may include both volatile and non-volatile, removable and non-removable media implemented in any method or technology for storage of information, such as computer-readable instructions, data structures, program modules, or other data.

Computer storage media include RAM, ROM, EEPROM, flash memory, or other memory technology, such as optical disk storage, magnetic cassettes, magnetic tape, magnetic disk storage, or other magnetic storage devices. Computer storage media do not include a propagated data signal. Communication media typically embody computer-readable instructions, data structures, program modules, or other data in a modulated data signal, such as a carrier wave, or other transport mechanisms and includes any information delivery media. The term “modulated data signal” means a signal that has one or more of its characteristics set or changed in such a manner as to encode information in the signal. By way of example, and not limitation, communication media include wired media, such as a wired network or direct-wired connection, and wireless media, such as acoustic, RF, infrared, and other wireless media. Combinations of any of the above should also be included within the scope of computer-readable media.

The memory 1428 may include computer-storage media in the form of volatile and/or non-volatile memory. The memory 1428 may be removable, non-removable, or a combination thereof. Exemplary memory includes solid-state memory, hard drives, optical-disc drives, etc. As illustrated in FIG. 14, the memory 1428 may store computer-readable, computer-executable instructions 1432a (e.g., software codes) that are configured to, when executed, cause the processor 1426 to perform various functions described herein, for example, some of the function described with reference to FIG. 1-6. Alternatively, the instructions 1432a may not be directly executable by processor 1426 but be configured to cause the node 1400 (e.g., when compiled and executed) to perform various functions described herein.

The processor 1426 may include an intelligent hardware device, for example, a central processing unit (CPU), a microcontroller, an ASIC, etc. The processor 1426 may include memory. The processor 1426 may process data 1430b and instructions 1432b received from the memory 1428, and information through the transceiver 1420, the baseband communications module, and/or the network communications module. The processor 1426 may also process information to be sent to the transceiver 1420 for transmission through the antenna 1436, to the network communications module for transmission to a core network.

The node 1400 may include an energy harvesting component 1450, which may be configured to harvest energy from the environment. The node 1400 may use the energy harvested from the environment in lieu of a dedicated internal power source, such as a battery. The energy harvesting component 1450 may be configured to harvest energy from one or more sources, such as, radio waves, solar, light, motion, vibration, heat, pressure, etc. For example, energy harvesting component 1450 may include a radio wave antenna (which may be the same as the antenna 1436 or may be a different antenna) to receive radio waves from the environment and to harvest energy from the received radio waves. As another example, the energy harvesting component 1450 may include one or more solar cells to harvest solar energy or harvest energy from the ambient light. As another example, the energy harvesting component 1450 may include one or more transducers to generate energy from motion, vibration, heat, pressure, etc.

The node 1400 may include one or more energy storage units, such as the energy storage capacitor 1455, to store energy harvested by the energy harvesting component 1450. The processor 1426 may be configured to determine the level of energy stored in the energy storage capacitor 1455.

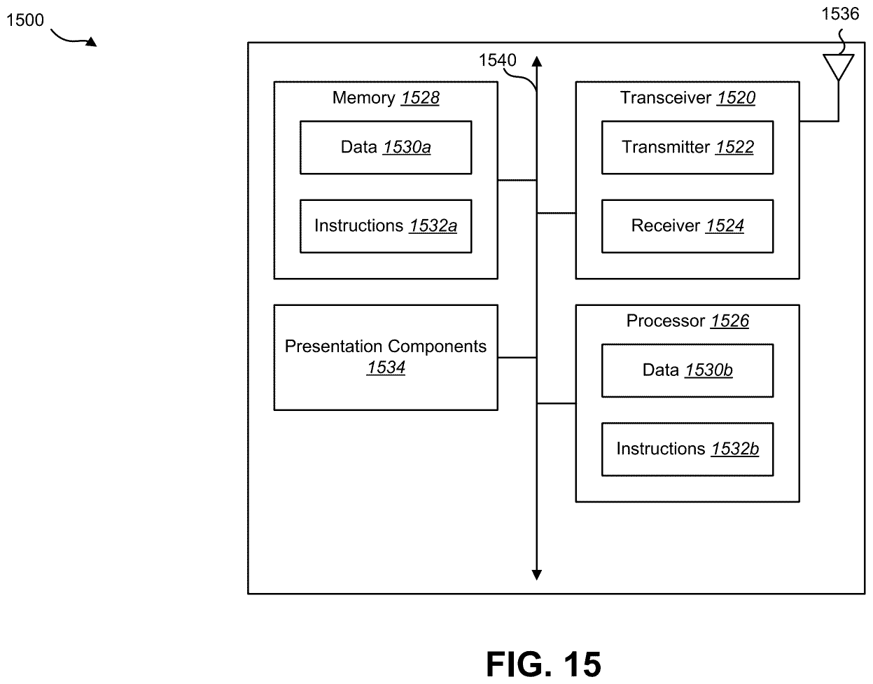

FIG. 15 illustrates a block diagram of a node for wireless communication 1500 according to an example implementation of the present disclosure. The node 1500 may, for example, be a UE, such as the UE 105 of FIG. 1. As shown in FIG. 15, the node 1500 may include transceiver 1520, processor 1526, memory 1528, one or more presentation components 1534, and at least one antenna 1536. The node 1500 may also include an RF spectrum band module, a base station communications module, a network communications module, and a system communications management module, input/output (I/O) ports, I/O components, and power supply (not explicitly shown in FIG. 15). Each of these components may be in communication with each other, directly or indirectly, over one or more buses 1540.

The transceiver 1520 having the transmitter 1522 and the receiver 1524 may be configured to transmit and/or receive time and/or frequency resource partitioning information. In some implementations, the transceiver 1520 may be configured to transmit in different types of subframes and slots including, but not limited to, usable, non-usable, and flexibly usable subframes and slot formats. The transceiver 1520 may be configured to receive data and control signaling.

The node 1500 may include a variety of computer-readable media. Computer-readable media may be any available media that may be accessed by the node 1500 and include both volatile and non-volatile media, removable and non-removable media. By way of example, and not limitation, computer-readable media may include computer storage media and communication media. Computer storage media may include both volatile and non-volatile, removable and non-removable media implemented in any method or technology for storage of information, such as computer-readable instructions, data structures, program modules, or other data.

Computer storage media include RAM, ROM, EEPROM, flash memory, or other memory technology, CD-ROM, digital versatile disks (DVD), or other optical disk storage, magnetic cassettes, magnetic tape, magnetic disk storage, or other magnetic storage devices. Computer storage media do not include a propagated data signal. Communication media typically embody computer-readable instructions, data structures, program modules, or other data in a modulated data signal, such as a carrier wave, or other transport mechanism and includes any information delivery media. The term “modulated data signal” means a signal that has one or more of its characteristics set or changed in such a manner as to encode information in the signal. By way of example, and not limitation, communication media include wired media, such as a wired network or direct-wired connection, and wireless media, such as acoustic, RF, infrared, and other wireless media. Combinations of any of the above should also be included within the scope of computer-readable media.

The memory 1528 may include computer-storage media in the form of volatile and/or non-volatile memory. The memory 1528 may be removable, non-removable, or a combination thereof. Exemplary memory includes solid-state memory, hard drives, optical-disc drives, etc. As illustrated in FIG. 15, the memory 1528 may store computer-readable, computer-executable instructions 1532a (e.g., software codes) that are configured to, when executed, cause the processor 1526 to perform various functions described herein, for example, some of the function described with reference to FIG. 1-6. Alternatively, the instructions 1532a may not be directly executable by processor 1526 but be configured to cause the node 1500 (e.g., when compiled and executed) to perform various functions described herein.

The processor 1526 may include an intelligent hardware device, for example, a central processing unit (CPU), a microcontroller, an ASIC, etc. The processor 1526 may include memory. The processor 1526 may process data 1530b and instructions 1532b received from the memory 1528, and information through the transceiver 1520, the baseband communications module, and/or the network communications module. The processor 1526 may also process information to be sent to the transceiver 1520 for transmission through the antenna 1536, to the network communications module for transmission to a core network.

One or more presentation components 1534 may present data indications to a person or other device. For example, one or more presentation components 1534 include a display device, speaker, printing component, vibrating component, etc.

From the above description, it is manifest that various techniques can be used for implementing the concepts described in the present application without departing from the scope of those concepts. Moreover, while the concepts have been described with specific reference to certain implementations, a person of ordinary skill in the art may recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

The term “computer-readable medium” refers to any available medium that can be accessed by a computer or a processor. The term “computer-readable medium,” as used herein, may denote a computer-and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the gNB or the wireless terminal according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or Hard Disk Drives (HDDs), and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB and the wireless terminal according to the systems and methods described above may be realized as an LSI that is a typical integrated circuit. Each functional block of the gNB and the wireless terminal may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned implementations may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

What is claimed is:

1. An electronic device or an ambient Internet of Things (AIoT) reader, comprising:
memory for storing instructions; and
a processor configured to execute the instructions to cause the electronic device to:
send a message on a physical random downlink control channel (PRDCH), wherein the message includes any combination of a paging identification (ID), a reader ID, and a paging re-transmission counter for random access paging;
receive a second message from energy harvesting electronic devices in a contention access region; and
determine whether to send a duplicate message based on second message detection results.

2. The electronic device of claim 1, wherein the processor is configured to send the duplicate message when the second message detection results comprise detecting a collision in one or more random access opportunities (ROs).

3. The electronic device of claim 1, wherein the processor is configured to send the duplicate message when the second message detection results comprise detecting more than one energy harvesting electronic devices reporting the same random ID.

4. The electronic device of claim 1, wherein the processor is configured to send the duplicate message when the second message detection results comprise determining that more responses from energy harvesting electronic devices are expected.

5. The electronic device of claim 4, wherein determining that more responses from energy harvesting electronic devices are expected comprises determining that some energy harvesting electronic devices sent a prior second message in a previous random access region.

6. The electronic device of claim 1, wherein the processor is configured not to send a subsequent duplicate message when all random access opportunities (ROs) in a previous contention access region are detected as idle.

7. The electronic device of claim 1, wherein the processor is configured not to send a subsequent duplicate message when no second messages are received and no collisions are detected.

8. A method, comprising:
sending a message on a physical random downlink control channel (PRDCH), wherein the message includes any combination of a paging identification (ID), a reader ID, and a paging re-transmission counter for random access paging;
receiving a second message from energy harvesting electronic devices in a contention access region; and
determining whether to send a duplicate message based on second message detection results.
